(19) United States
(12) Patent Application Publication
(10) Pub. No.: US 2026/0158941 A1
(43) Pub. Date: Jun. 11, 2026

(54) VEHICLE POSITIONING FOR WIRELESS CHARGING OPPORTUNITY

(71) Applicant: International Truck Intellectual Property Company, LLC, Lisle, IL (US)

(72) Inventor: Dean Alan Oppermann, Minooka, IL (US)

(73) Assignee: International Truck Intellectual Property Company, LLC, Lisle, IL (US)

(21) Appl. No.: 18/976,711

(22) Filed: Dec. 11, 2024

(51) Int. Cl. B60L 53/126; B60L 53/36; B60L 53/37; B60L 53/39

(52) U.S. Cl. CPC B60L 53/126; B60L 53/36; B60L 53/37; B60L 53/39; B60L 2250/16

(57) ABSTRACT

An electric vehicle includes an electric vehicle battery, a receiver coil configured to receive power wirelessly from a transmitter coil outside the electric vehicle to charge the electric vehicle battery, a controller and a vehicle control module coupled to the controller. The controller is configured to receive information indicating a position of the transmitter coil and a power level at which the receiver coil is receiving power from the transmitter coil. The controller is configured to determine a vehicle height adjustment based on the received information. The vehicle control module configured to adjust a vertical height of the electric vehicle according to the vehicle height adjustment.

### FIELD OF THE INVENTION

The present disclosure relates generally to inductive charging, and more particularly to a system and method of vehicle positioning for wireless charging opportunity.

### BACKGROUND

The share of electric vehicles, such as hybrid electrical vehicles and full electric vehicles, on the roadways is expected to increase significantly over the next decade or so. Infrastructure is currently being developed to support the transition from combustion to electric motor vehicles; however, there is much room for growth. One primary way of charging an electric vehicle battery is by physically connecting a charging cable from a stationary power supply source, such as a public or gas station charging station, to a mating charging port on the vehicle. Wireless or inductive charging of electric vehicles is less common. Positioning is typically performed with painted lines on the road, or rails that physically align the vehicle for charging. Unfortunately, such charging may not be efficient on a more widespread use due to vehicle-to-vehicle design variability and environment factors. For example, a layer of snow on the ground can alter the distance between primary and secondary coils, making the gap between the two even larger and thereby reducing charging efficiency, which is a function of the gap between the coils. Other environmental factors include the presence of potholes or other irregular variations in the ground. There is a need for efficient wireless/inductive charging that is adaptable to varying environmental factors as well as vehicle-to-vehicle design variability. There is much room for improvements in inductive charging of electric vehicles.

### SUMMARY

According to a first aspect of the present disclosure, an electric vehicle is provided. The electric vehicle includes an electric vehicle battery; a receiver coil coupled to the electric vehicle battery and configured to receive power wirelessly from a transmitter coil outside the electric vehicle to charge the electric vehicle battery; a controller coupled to the receiver coil. The controller is configured to: receive information from at least one position sensor indicating a position of the transmitter coil relative to a position of the receiver coil; receive information from at least one power level sensor indicating a power level at which the receiver coil is receiving the power wirelessly from the transmitter coil; determine whether the receiver and transmitter coils are aligned based on at least one of the information indicating the position of the transmitter coil and the information indicating the power level at which the receiver coil is receiving the power wirelessly; determine a vehicle height adjustment, as a result of a determination that the receiver coil is not aligned; a vehicle control module coupled to the controller, the vehicle control module configured to adjust a vertical height of the electric vehicle according to the vehicle height adjustment.

In one embodiment of the first aspect, the controller is configured to detect when the electric vehicle is in proximity to the receiver coil in a charge-ready state and wherein the determination of whether the receiver and transmitter coils are aligned is in response to the detection. In one embodiment of the first aspect, the controller is configured to determine whether the receiver and transmitter coils are aligned by being configured to measure an air gap between the receiver and transmitter coils based on the at least one of the information from the at least one position sensor and the at least one power level sensor; and determine the vehicle height adjustment by being configured to compare the measured air gap with a predetermined optimal air gap.

In one embodiment of the first aspect, the vehicle control module comprises a vertical vehicle height adjustment module coupled to the controller, the vertical vehicle height adjustment module configured to cause the electric vehicle to move one of up and down to adjust the measured air gap towards the predetermined optimal air gap. In another embodiment of the first aspect, the electric vehicle further includes an in-vehicle display coupled to the controller, the controller configured to cause the in-vehicle display to display the vehicle height adjustment. In another embodiment of the first aspect, the transmitter coil is a charging pad and the at least one position sensor comprises a downward-facing camera coupled to the controller and configured to capture image data of the charging pad, the image data indicating the position of the transmitter coil relative to a position of the receiver coil.

In another embodiment of the first aspect, the at least one position sensor comprises at least one of a forward-facing camera and a forward-facing radar coupled to the controller and configured to provide information indicating a horizontal position of the transmitter coil relative to the position of the receiver coil. In another embodiment of the first aspect, the at least one power level sensor comprises an electromagnetic charging coupler current detector coupled to the controller and configured to detect a current in the receiver coil and send information indicating the detected current to the controller; and the controller is configured to use the information indicating the detected current to determine the vehicle height adjustment a method of positioning an electric vehicle for inductive charging is provided. The method includes providing an electric vehicle comprising an electric vehicle battery, a vehicle control module, a controller and a receiver coil coupled to the controller and the electric vehicle battery, the receiver coil configured to receive power wirelessly from a transmitter coil outside the electric vehicle to charge the electric vehicle battery; receiving, by the controller, information from at least one position sensor indicating a position of the transmitter coil relative to a position of the receiver coil; receiving, by the controller, information from at least one power level sensor indicating a power level at which the receiver coil is receiving the power wirelessly from the transmitter coil; determining, by the controller, whether the receiver and transmitter coils are aligned based on at least one of the information indicating the position of the transmitter coil and the information indicating the power level at which the receiver coil is receiving the power wirelessly; determining, by the controller, a vehicle height adjustment, as a result of a determination that the receiver coil is not aligned; and adjusting, by the vehicle control module, a vertical height of the electric vehicle according to the vehicle height adjustment.

In one embodiment of the second aspect, the method further includes detecting, by the controller, when the electric vehicle is in proximity to the receiver coil in a charge-ready state and wherein the determination of whether the receiver and transmitter coils are aligned is in response to the detection. In another embodiment of the second aspect, the determining whether the receiver and transmitter coils are aligned comprises measuring an air gap between the receiver and transmitter coils based on the at least one of the information from the at least one position sensor and the at least one power level sensor; and the determining the vehicle height adjustment comprises comparing the measured air gap with a predetermined optimal air gap. In another embodiment of the second aspect, the vehicle control module comprises a vertical vehicle height adjustment module coupled to the controller; and the method further include causing, by the vertical vehicle height adjustment module, the electric vehicle to move one of up and down to adjust the measured air gap towards the predetermined optimal air gap.

In another embodiment of the second aspect, the method further includes providing an in-vehicle display coupled to the controller; and causing, by the controller, the in-vehicle display to display the vehicle height adjustment. In another embodiment of the second aspect, the method further includes providing the transmitter coil as a charging pad; providing the at least one position sensor as a downward-facing camera coupled to the controller; and capturing, by the downward-facing camera, image data of the charging pad, the image data indicating the position of the transmitter coil relative to a position of the receiver coil. In another embodiment of the second aspect, the method further includes providing the at least one position sensor as at least one of a forward-facing camera and a forward-facing radar coupled to the controller; and providing, by the at least one of the forward-facing camera and the forward-facing radar, information indicating a horizontal position of the transmitter coil relative to the position of the receiver coil.

In another embodiment of the second aspect, the method further includes providing the at least one power level sensor as an electromagnetic charging coupler current detector coupled to the controller; detecting, by the electromagnetic charging coupler current detector, a current in the receiver coil and sending information indicating the detected current to the controller; and using, by the controller, the information indicating the detected current to determine the vehicle height adjustment.

According to a third aspect of the present disclosure, an electric vehicle is provided. The electric vehicle includes an electric vehicle battery; a receiver coil coupled to the electric vehicle battery and configured to receive power wirelessly from a transmitter coil outside the electric vehicle to charge the electric vehicle battery; and a controller coupled to the receiver coil. The controller is configured to receive information from at least one position sensor indicating a position of the transmitter coil relative to a position of the receiver coil; receive information from at least one power level sensor indicating a power level at which the receiver coil is receiving the power wirelessly from the transmitter coil; detect when the electric vehicle is in proximity to the receiver coil in a charge-ready state; in response to the detection, measure an air gap between the receiver and transmitter coils based on at least one of the information indicating the position of the transmitter coil and the information indicating the power level at which the receiver coil is receiving the power wirelessly; determine a vehicle height adjustment by comparing the measured air gap with a predetermined optimal air gap; a vehicle control module coupled to the controller, the vehicle control module configured to cause the electric vehicle to move one of up and down to adjust the measured air gap towards the predetermined optimal air gap.

In one embodiment of this third aspect, the electric vehicle further includes an in-vehicle display coupled to the controller, the controller configured to cause the in-vehicle display to display the vehicle height adjustment. In another embodiment of the third aspect, the transmitter coil is a charging pad and the at least one position sensor comprises a downward-facing camera coupled to the controller and configured to capture image data of the charging pad, the image data indicating the position of the transmitter coil relative to a position of the receiver coil. In another embodiment of this third aspect, the at least one power level sensor comprises an electromagnetic charging coupler current detector coupled to the controller and configured to detect a current in the receiver coil and send information indicating the detected current to the controller; and the controller is configured to use the information indicating the detected current to determine the vehicle height adjustment.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of an example electric vehicle in a first position, according to one embodiment of the present disclosure;

FIG. 2 is a schematic diagram of the electric vehicle shown in FIG. 1 in a second charge-ready position, according to an embodiment of the present disclosure;

FIG. 3 is a schematic diagram of an example circuit and transmitter and receiver coils for inductively charging electric vehicles according to another embodiment of the present disclosure;

FIG. 4 is a flow diagram illustrating another embodiment of the present disclosure;

FIG. 5 is a block diagram of an example controller according to an embodiment of the present disclosure; and

FIG. 6 is a flowchart of a side of an example method of positioning an electric vehicle for inductive charging according to an embodiment of the present disclosure.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

As stated above, infrastructure is currently being developed to support the transition from combustion to electric motor vehicles. One primary way of charging an electric vehicle battery is by physically connecting a charging cable from a stationary power supply source, such as a public or gas station charging station, to a mating charging port on the vehicle. However, for very large vehicles, such as work trucks, buses, and the like which require a much larger amount of power than conventional personal vehicles, the size of a charging cable sufficient to support such charging would be too heavy for the average adult to even lift. Thus, a system and method for practically charging large, heavy-duty work trucks, buses and like is needed.

Additionally, there is a limit to the amount of power that can be practically provided by the current power grid infrastructure and with the expected increase in use of electric vehicles, that limit will be exceeded; unless changes are made to the power grid infrastructure to increase power output and technologies are developed to greatly increase the efficiency of electric vehicle charging. Accordingly, the present disclosure advantageously provides a system and method for efficient charging of electric vehicle batteries and particularly efficient and practicable charging of large, heavy-duty vehicles.

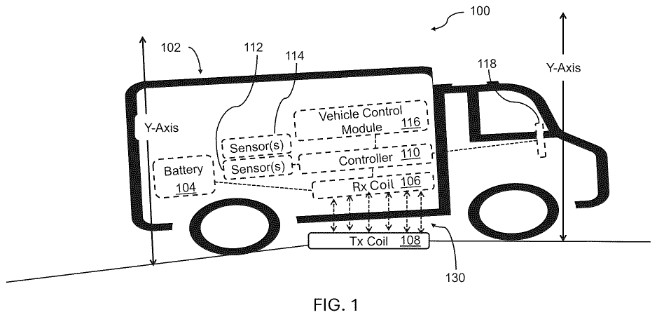

Referring to FIG. 1, a system 100 for positioning an electric vehicle for efficient inductive charging according to one embodiment of the present disclosure is described. The system 100 includes an electric vehicle 102 which has an electric vehicle battery 104 that supplies power to an electric motor of the electric vehicle 102. The electric motor provides the electric vehicle 102 with locomotion ability to move from one place to another. The electric vehicle 102 is shown as a delivery truck in FIG. 1. In other embodiments, the electric vehicle 102 may be other types of trucks, buses, cars, and the like. Although the present disclosure is provided for charging large, heavy-duty vehicles, it is contemplated that smaller vehicles may also use the technology disclosed herein. The electric vehicle battery 104 may be a lithium-ion battery, or another known type of rechargeable battery that powers electric motors in electric vehicles 102. Although FIG. 1 shows one electric vehicle battery 104, the present disclosure is not limited to electric vehicles with a single electric battery. It is contemplated that the electric vehicles of the present disclosure will likely have more than one electric battery as is the case with many electric vehicles.

The electric vehicle 102 further includes one or more receiver coils 106 electrically coupled to the electric vehicle battery 104. The receiver coil 106 is located in a bottom portion of the electric vehicle 102 to provide a close proximity to one or more transmitter coils 108, which are located on a ground surface outside the electric vehicle 102. In other embodiments, the receiver coil 106 may be positioned in other areas inside the electric vehicle 102. The receiver coil 106 (also referred to as a secondary coil) is configured to receive power wirelessly from the transmitter coil 108 (also referred to as a primary coil) to charge the electrical vehicle battery 104. The receiver coil 106 may alternatively be mounted on an underside of the electric vehicle 102 for an even closer proximity to the ground surface on which the transmitter coil 108 is located. The receiver coil 106 is parallel to a plane defined by the underside of the electric vehicle 102. The transmitter coil 108 is contained within a charging pad. In alternative embodiments, the transmitter coil 108 may be contained within other structures. In some embodiments, the charging pad is portable. In other embodiments, the transmitter coil is contained within a fixed structure.

It is noted that the underside of vehicles is typically not entirely horizontal to the ground plane. Most vehicles have a particular rake or slope, usually with the front being lower to the ground than the rear of the vehicle. This further underlies the benefit of the present disclosure in achieving optimal wireless/inductive charging. Stated another way, it is likely that a receiver coil in the vehicle will hardly ever be perfectly parallel to the ground plane for the reasons described herein above (e.g., potholes, different vehicle rakes, other environmental conditions, vehicle-to-vehicle variation, etc.). Because charging efficiency is dependent on the air gap between coils, embodiments of the present disclosure provide arrangements to optimally align receiver coil to transmitter coil, preferably to be parallel with one another, irrespective of the ground plane angles, the vehicle plane angles or environmental factors, such as weather, temperature, and the like. For the avoidance of doubt, embodiments of the present disclosure are not necessarily concerned with making the vehicle level with the ground; but is instead concerned with aligning receiver and transmitter coils to be parallel, irrespective of other variable factors (e.g., ground, vehicle variability, air tire pressure variability due to changing temperature variations, weather conditions such as inches of snow, etc.).

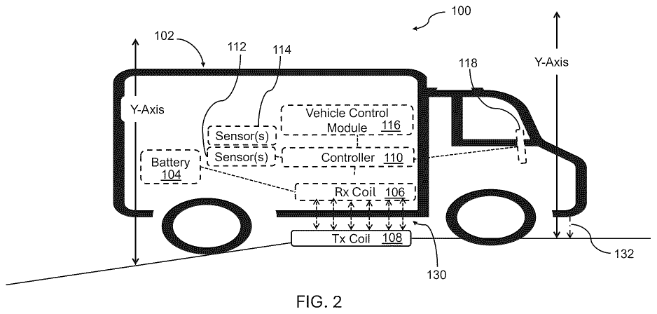

The system 100 also includes a controller 110, one or more position sensors 112, one or more power level sensors 114, a vehicle control module 116 and an in-vehicle display 118, each coupled to the controller 110 and located inside or on the electric vehicle 102. The controller 110 is configured to receive information from the sensors 112, 114 to instruct the electric vehicle 102 and/or a driver of the electric vehicle to optimally align the receiver coil 106 to the transmitter coil 108 for efficient charging. These components are shown in FIG. 1 and FIG. 2 as being within the cargo compartment of the truck due to the space limitations of the figures; however, it should be apparent that the components would likely be in other locations inside or on the electric vehicle 102. For example, the electric vehicle battery 104 is likely located between frame rails under or behind the cab of the electric vehicle 102 and the position sensor 112 is preferably located proximately to the receiver and transmitter coils 106, 108.

The position sensor 112 is configured to indicate a position of the transmitter coil 108 relative to a position of the receiver coil 106. In one embodiment, the position sensor 112 is a downward-facing camera oriented and configured to capture image data of the transmitter coil 108. The image data indicates the position of the transmitter coil 108 relative to the position of the receiver coil 106. In one embodiment, a plurality of images are captured and sent to the controller 110 or other image processor configured to determine a position of the transmitter coil 108 based on, for example, a predetermined orientation and location of the downward-facing camera, a speed that the electric vehicle 102 is traveling, an image capture rate, predetermined dimensions of the charging pad, or other information that can be used to determine that the receiver coil 106 is in proximity to the transmitter coil 108 and further, to determine a distance between the coils 106, 108 in the Y-axis. In one embodiment, an identifying radio frequency (RF) tag or near-field (NF) tag is attached to the transmitter coil 108 and another RF tag or NF tag is attached to the receiver coil 106 or otherwise on the electric vehicle 102. The tag on the transmitter coil 108 may transmit an identifying RF signal, which is received by the tag on the receiver coil 106 when the two are in proximity to one another, or vice versa. This proximity detection event may indicate the receiver coil 106 is ready to receive a charge (i.e., a charge-ready state). In further embodiments, the position sensors 112 may also include other sensors, such as a forward-facing camera and a forward-facing radar for determining an orientation in the X-Z axis (horizontal plane) of the transmitter coil 108 relative to the receiver coil 106. In other embodiments, the position sensors 112 include other types of position sensors, such as lidar, etch and the like.

Other sensors that may be used to determine a distance between the coils 106, 108 in the Y-axis according to the present disclosure include: ultrasonic sensor to measure a height between the coils according to a predetermined height; G sensor typically in the transmission that indicates when the vehicle is level. The sensors described herein are non-limiting examples.

The power level sensor 114 is configured to indicate a power level at which the receiver coil 106 is receiving the power wirelessly from the transmitter coil 108. In one embodiment, the power level sensor 114 is an electromagnetic charging coupler current detector. The current detector detects the current generated at the receiver coil 106 by the magnetic field of the transmitter coil 108. The current information is sent to the controller 110, which is configured to determine whether the receiver and transmitter coils 106, 108 are aligned with one another based on the power level information and the position information. To save processing resources, the controller 110 may be configured to determine whether the receiver and transmitter coils 106, 108 are optimally aligned in response to the proximity detection event.

In alternative embodiments, the power level sensor is the electric vehicle battery. The electric vehicle battery is configured to monitor its own charging rate. In one example use case, the transmitter coil is turned on and therefore begins to transmit energy. The electric vehicle can be driven over the transmitter coil while the resulting charge rate of the electric vehicle battery is monitored. As improved orientation/alignment of the receiver coil to the transmitter coil is achieved in the X-Z plane, the charging rate in the electric vehicle battery should increase. Similarly, as the electric vehicle is dropped down along the Y-axis closer to the transmitter coil, the charging rate will gradually increase (since the air gap is gradually decreasing). When the charging rate begins to decrease, the controller may determine that the optimal air gap was achieved and slightly raise the electric vehicle to the height at which the peak charging rate occurred. This embodiment eliminates the need for an additional power level sensor, because the electric vehicle battery is the sensor.

By receiving the information described herein, the controller 110 is able to detect when the electric vehicle 102 has been driven over the transmitter coil 108 and to then calculate how far and in what direction the electric vehicle 102 is to move in the Y-, X-, and/or Z-axis in order to optimize the wireless charging.

As shown in FIG. 1, the electric vehicle 102 may be driven over the charging pad in preparation for wireless charging. Efficient wireless charging is a function of the alignment, positioning and air gap between the coils 106, 108. FIG. 1 illustrates an air gap 130 between the receiver coil 106 and the transmitter coil 108. The controller 110 is configured to measure the air gap 130 between the coils 106, 108 based on the information received from the one or more position sensors 112 and the one or more power level sensors 114. The controller 110 may be further configured to compare the measured air gap 130, at a time, t, to a predetermined optimal air gap. When the controller 110 determines that the measured air gap 130, at time, t, is less than the predetermined optimal air gap, the controller 110 may determine that the receiver coil 106 is not aligned with the transmitter coil 108 in the Y-axis.

As a result, the controller 110 may determine a vehicle height adjustment to move the electric vehicle 102 up or down to the predetermined optimal air gap and may communicate such vehicle height adjustment to the vehicle control module 116 which is configured to adjust a vertical height 132 of the electric vehicle 102 accordingly, as illustrated in FIG. 2. FIG. 2 represents one embodiment in which a front part of the electric vehicle 102 is lowered closer to the ground surface to reduce the air gap 130 and make it consistent across the length of the air gap 130, since the electric vehicle 102 is partly on a hill. This is merely for illustrative purposes to show that in some embodiments the vehicle height of the front and rear parts of the electric vehicle 102 may be separately adjustable. In other embodiments, they may not be separately adjustable.

The vehicle control module 116 may be any known system for selectively increasing and decreasing a vehicle height, such as an air spring suspension system. The vehicle control module 116 is preferably communicatively coupled to the controller 110 and configured to automatically adjust the vehicle height according to the information from the controller 110. In some embodiments, the vehicle height adjustment is displayed to a driver in the cab on the in-vehicle display 118. In such embodiments, the driver may be prompted to make the adjustments using controls in the cab.

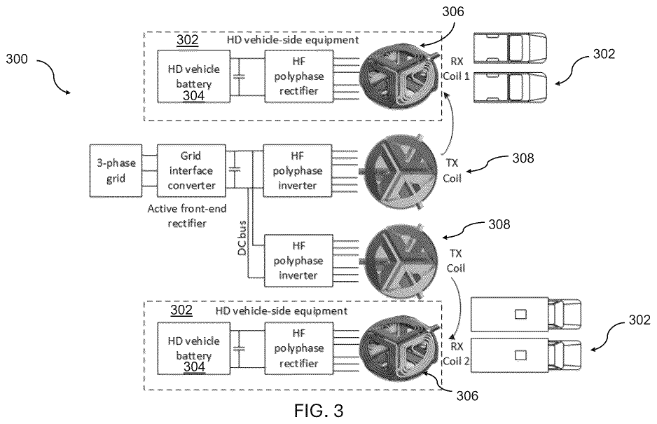

Referring now to FIG. 3, one example implementation of receiver and transmitter coils for wirelessly charging electric vehicles according to the present disclosure is described. The system 300 includes electric vehicles 302. Receiver coils 306 are located inside the electric vehicles 302. Receiver coil 306 is coupled to the electric vehicle battery 304 according to the circuit diagram in FIG. 3. The alternating electromagnetic field generated by the transmitter coil 308 induces an alternating current (AC) in the receiver coil 306. The rectifier converts the AC current to direct current (DC) to charge the electric vehicle battery 304. The transmitter coils 308 are located outside the electric vehicles 302 on the ground surface. Although the present disclosure describes that the transmitter coils are on the ground surface 308, it is contemplated that they may also be located on other like surfaces over which vehicles can be driven, such as, for example, a slightly raised platform. Transmitter coil 308 is coupled to a 3-phase power grid according to the circuit diagram in FIG. 3. The converter supplies power to the inverter and operates as a voltage or current source to the transmitter coil 308.

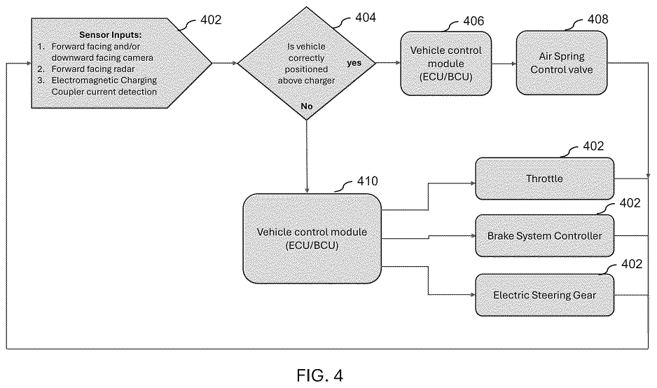

Referring to the flow diagram in FIG. 4, one example implementation of a method of positioning an electric vehicle for efficient wireless charging is described. In block 402, sensor inputs are received from the forward-facing camera, downward-facing camera, forward-facing radar, and electromagnetic charging coupler current detector, as described herein throughout. In block 404, the method includes determining if the electric vehicle is correctly positioned above the charging/transmitter coil. If yes, in block 406, the vehicle control module is activated to control, in block 408, an air spring control valve on the electric vehicle to cause the electric vehicle to move up or down (Y-axis) towards the predetermined optimal air gap. If no, in block 410, the vehicle control module is activated to control, in blocks 412, 414 and 416, the throttle, brake system controller and electric steering gear on the electric vehicle to cause the electric vehicle to move left, right, forward or backward to further align the receiver coil to the transmitter coil along the X-Z plane. In a preferred embodiment, electric vehicle movement to align the coils is autonomously performed by the electric vehicle according to the present disclosure.

In other embodiments, electric vehicle movement to align the coils is user-assisted. For example, the downward-facing camera captures real-time video of the ground underneath the electric vehicle; the controller is configured to cause the display to visually indicate to the user how much further the user should move lower the vehicle achieve optimal air gap. The controller can cause an image of a circle to be displayed on the display, where the circle is calibrated as an overlay outline on the display, and optimal air gap is indicated by the circle overlay outline on the display aligning with the real-time video image of the transmitter coil.

By using sensors (radar, lidar, cameras, etch, etc.) and drive-by-wire hardware that is currently being developed, communication between the charging pad/transmitter coil and the electric vehicle can be established and used in conjunction with steering assist motor along with EBS brake system than drive-by-wire throttle to optimize vehicle positioning. The air gap between the two coils can be optimized using a ride height control system.

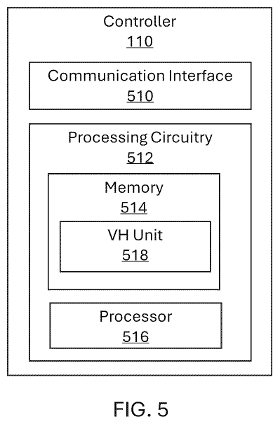

Referring to FIG. 5, one example implementation of the Controller 110 is described. The controller 110 includes a communication interface 510 and processing circuitry 512. The communication interface 510 is configured to set up and maintain a wired or wireless connection with an interface of a different communication device of the system, such as the vehicle control module 116 and one or more of the sensors 112, 114. The communication interface 510 may include a radio interface for setting up and maintaining a wireless connection to the controller 110, such as one or more radio frequency (RF) transmitters, receivers or transceivers. The processing circuitry 512 includes memory 514 and one or more processors 516. The processing circuitry 512 and/or processors 516 may be, for example, a central processing unit (CPU), field programmable gate away (FPGA), application-specific integrated circuitry (ASIC) and the like. The memory 514 may include any kind of volatile and/or nonvolatile memory, e.g., cache, buffer memory, random access memory (RAM), read only memory (ROM) and the like. The memory 514 includes a vehicle height (VH) unit 518 which has computer instructions that, when executed by the processor 516, causes the processor 516 to perform the methods and techniques described herein.

The HV unit 518 has computer instructions to cause the processor 516 to receive, via the communication interface 510, information from at least one position sensor 112 indicating a position of the transmitter coil 108 relative to the position of the receiver coil 106. The HV unit 518 has computer instructions to cause the processor 516 to receive, via the communication interface 510, information from at least one power level sensor 114 indicating a power level at which the receiver coil 106 is receiving the power wirelessly from the transmitter coil 108. The HV unit 518 has computer instructions to cause the processor 516 to determine whether the receiver and transmitter coils 106, 108 are aligned based on the information indicating the position of the transmitter coil 108 and the information indicating the power level at which the receiver coil 106 is receiving the power wirelessly. The HV unit 518 has computer instructions to cause the processor 516 to determine a vehicle height adjustment, as a result of a determination that the receiver coil 106 is not aligned with the transmitter coil 108. The HV unit 518 has computer instructions to cause the vehicle control module 116 to adjust a vertical height (along the Y-axis) of the electric vehicle 100 according to the vertical height adjustment.

The HV unit 518 has computer instructions to cause the processor 516 to detect when the electric vehicle 100 is in proximity to the receiver coil 106 in a charge-ready state and wherein the determination of whether the receiver and transmitter coils 106, 108 are aligned is in response to the detection. The HV unit 518 has computer instructions to cause the processor 516 to measure an air gap 130 between the receiver and transmitter coils 106, 108 based on at least one of the information from the at least one position sensor 112 and the at least one power level (e.g., charge rate, current level, current flow, and the like) sensor 114; and compare the measured air gap with a predetermined optimal air gap. The vehicle control module 116 may be a vertical vehicle height adjustment module. The HV unit 518 has computer instructions to cause the vertical vehicle height adjustment module to move the electric vehicle 100 one of up and down to adjust the measured air gap towards the predetermined optimal air gap. The HV unit 518 has computer instructions to cause the in-vehicle display 118 to display the vehicle height adjustment.

The transmitter coil 108 may be formed as a charging pad in some embodiments. The position sensor(s) 112 may be formed as a downward-facing camera coupled to the controller 110. The HV unit 518 has computer instructions to cause the processor 516 to cause the downward-facing camera to capture image data of the charging pad. The image data indicates the position of the transmitter coil 108 relative to a position of the receiver coil 106. The position sensor(s) 112 may be formed as at least one of a forward-facing camera and a forward-facing radar coupled to the controller 110. The forward-facing camera and/or the forward-facing radar may provide information indicating a horizontal position of the transmitter coil 108 relative to the position of the receiver coil 106. The power level sensor(s) 114 may be formed as an electromagnetic charging coupler current detector coupled to the controller 110. The electromagnetic charging coupler current detector detects a current in the receiver coil 106 and sends information indicating the detected current to the controller 110. The HV unit 518 has computer instructions to cause the processor 516 to use the information indicating the detected current to determine the vehicle height adjustment.

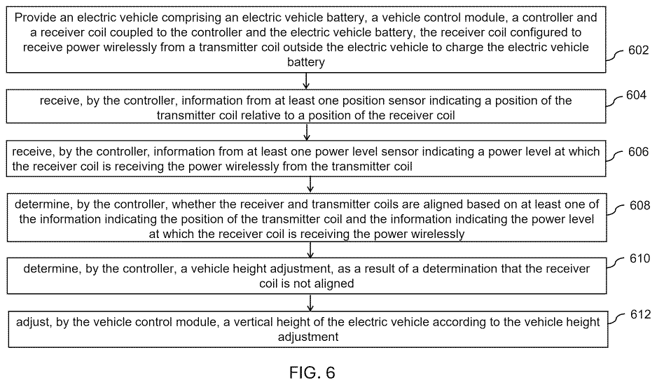

Referring to FIG. 6, an example method of positioning an electric vehicle for inductive charging is described. The method includes providing (S602) an electric vehicle 100 including an electric vehicle battery 104, a vehicle control module 116, a controller 110 and a receiver coil 106 coupled to the controller 110 and the electric vehicle battery 104, the receiver coil 106 configured to receive power wirelessly from a transmitter coil 108 outside the electric vehicle 100 to charge the electric vehicle battery 104. The method includes receiving (S604), by the controller 110, information from at least one position sensor 112 indicating a position of the transmitter coil 108 relative to a position of the receiver coil 106. The method includes receiving (S606), by the controller 110, information from at least one power level sensor 114 indicating a power level at which the receiver coil 106 is receiving the power wirelessly from the transmitter coil 108. The method includes determining (S608), by the controller 110, whether the receiver and transmitter coils 106, 108 are aligned based on the information indicating the position of the transmitter coil 108 and the information indicating the power level at which the receiver coil 106 is receiving the power wirelessly. The method includes determining (S610), by the controller 110, a vehicle height adjustment, as a result of a determination that the receiver coil 106 is not aligned. The method includes adjusting (S612), by the vehicle control module 116, a vertical height of the electric vehicle 100 according to the vehicle height adjustment.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

An electric vehicle includes an electric vehicle battery; a receiver coil coupled to the electric vehicle battery and configured to receive power wirelessly from a transmitter coil outside the electric vehicle to charge the electric vehicle battery; a controller coupled to the receiver coil and a vehicle control module coupled to the controller. The controller is configured to receive information from at least one position sensor indicating a position of the transmitter coil relative to a position of the receiver coil; receive information from at least one power level sensor indicating a power level at which the receiver coil is receiving the power wirelessly from the transmitter coil; determine whether the receiver and transmitter coils are aligned based on at least one of the information indicating the position of the transmitter coil and the information indicating the power level at which the receiver coil is receiving the power wirelessly; and determine a vehicle height adjustment, as a result of a determination that the receiver coil is not aligned. The vehicle control module is configured to adjust a vertical height of the electric vehicle according to the vehicle height adjustment. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

What is claimed is:

1. An electric vehicle comprising:
an electric vehicle battery;
a receiver coil coupled to the electric vehicle battery and configured to receive power wirelessly from a transmitter coil outside the electric vehicle to charge the electric vehicle battery;
a controller coupled to the receiver coil, the controller configured to:
receive information from at least one position sensor indicating a position of the transmitter coil relative to a position of the receiver coil;
receive information from at least one power level sensor indicating a power level at which the receiver coil is receiving the power wirelessly from the transmitter coil;
determine whether the receiver and transmitter coils are aligned based on at least one of the information indicating the position of the transmitter coil and the information indicating the power level at which the receiver coil is receiving the power wirelessly;
determine a vehicle height adjustment, as a result of a determination that the receiver coil is not aligned;
a vehicle control module coupled to the controller, the vehicle control module configured to adjust a vertical height of the electric vehicle according to the vehicle height adjustment.

2. The electric vehicle of claim 1, wherein the controller is configured to detect when the electric vehicle is in proximity to the receiver coil in a charge-ready state and wherein the determination of whether the receiver and transmitter coils are aligned is in response to the detection.

3. The electric vehicle of claim 1, wherein the controller is configured to:
determine whether the receiver and transmitter coils are aligned by being configured to measure an air gap between the receiver and transmitter coils based on the at least one of the information from the at least one position sensor and the at least one power level sensor; and
determine the vehicle height adjustment by being configured to compare the measured air gap with a predetermined optimal air gap.

4. The electric vehicle of claim 1, wherein the vehicle control module comprises a vertical vehicle height adjustment module coupled to the controller, the vertical vehicle height adjustment module configured to cause the electric vehicle to move one of up and down to adjust the measured air gap towards the predetermined optimal air gap.

5. The electric vehicle of claim 1, further comprising:
an in-vehicle display coupled to the controller, the controller configured to cause the in-vehicle display to display the vehicle height adjustment.

6. The electric vehicle of claim 1, wherein the transmitter coil is a charging pad and the at least one position sensor comprises a downward-facing camera coupled to the controller and configured to capture image data of the charging pad, the image data indicating the position of the transmitter coil relative to a position of the receiver coil.

7. The electric vehicle of claim 1, wherein the at least one position sensor comprises at least one of a forward-facing camera and a forward-facing radar coupled to the controller and configured to provide information indicating a horizontal position of the transmitter coil relative to the position of the receiver coil.

8. The electric vehicle of claim 1, wherein:
the at least one power level sensor comprises an electromagnetic charging coupler current detector coupled to the controller and configured to detect a current in the receiver coil and send information indicating the detected current to the controller; and
the controller is configured to use the information indicating the detected current to determine the vehicle height adjustment.

9. A method of positioning an electric vehicle for inductive charging comprising:
providing an electric vehicle comprising an electric vehicle battery, a vehicle control module, a controller and a receiver coil coupled to the controller and the electric vehicle battery, the receiver coil configured to receive power wirelessly from a transmitter coil outside the electric vehicle to charge the electric vehicle battery;
receiving, by the controller, information from at least one position sensor indicating a position of the transmitter coil relative to a position of the receiver coil;
receiving, by the controller, information from at least one power level sensor indicating a power level at which the receiver coil is receiving the power wirelessly from the transmitter coil;
determining, by the controller, whether the receiver and transmitter coils are aligned based on at least one of the information indicating the position of the transmitter coil and the information indicating the power level at which the receiver coil is receiving the power wirelessly;
determining, by the controller, a vehicle height adjustment, as a result of a determination that the receiver coil is not aligned; and
adjusting, by the vehicle control module, a vertical height of the electric vehicle according to the vehicle height adjustment.

10. The method of claim 9, further comprising:
detecting, by the controller, when the electric vehicle is in proximity to the receiver coil in a charge-ready state and wherein the determination of whether the receiver and transmitter coils are aligned is in response to the detection.

11. The method of claim 9, wherein:
the determining whether the receiver and transmitter coils are aligned comprises measuring an air gap between the receiver and transmitter coils based on the at least one of the information from the at least one position sensor and the at least one power level sensor; and
the determining the vehicle height adjustment comprises comparing the measured air gap with a predetermined optimal air gap.

12. The method of claim 9, wherein the vehicle control module comprises a vertical vehicle height adjustment module coupled to the controller; and
the method further comprises causing, by the vertical vehicle height adjustment module, the electric vehicle to move one of up and down to adjust the measured air gap towards the predetermined optimal air gap.

13. The method of claim 9, further comprising:
providing an in-vehicle display coupled to the controller; and
causing, by the controller, the in-vehicle display to display the vehicle height adjustment.

14. The method of claim 9, further comprising:
providing the transmitter coil as a charging pad;
providing the at least one position sensor as a downward-facing camera coupled to the controller; and
capturing, by the downward-facing camera, image data of the charging pad, the image data indicating the position of the transmitter coil relative to a position of the receiver coil.

15. The method of claim 9, further comprising:
providing the at least one position sensor as at least one of a forward-facing camera and a forward-facing radar coupled to the controller; and
providing, by the at least one of the forward-facing camera and the forward-facing radar, information indicating a horizontal position of the transmitter coil relative to the position of the receiver coil.

16. The method of claim 9, further comprising:
providing the at least one power level sensor as an electromagnetic charging coupler current detector coupled to the controller;
detecting, by the electromagnetic charging coupler current detector, a current in the receiver coil and sending information indicating the detected current to the controller; and
using, by the controller, the information indicating the detected current to determine the vehicle height adjustment.

17. An electric vehicle comprising:
an electric vehicle battery;
a receiver coil coupled to the electric vehicle battery and configured to receive power wirelessly from a transmitter coil outside the electric vehicle to charge the electric vehicle battery;
a controller coupled to the receiver coil, the controller configured to:
receive information from at least one position sensor indicating a position of the transmitter coil relative to a position of the receiver coil;
receive information from at least one power level sensor indicating a power level at which the receiver coil is receiving the power wirelessly from the transmitter coil;
detect when the electric vehicle is in proximity to the receiver coil in a charge-ready state;
in response to the detection, measure an air gap between the receiver and transmitter coils based on at least one of the information indicating the position of the transmitter coil and the information indicating the power level at which the receiver coil is receiving the power wirelessly;
determine a vehicle height adjustment by comparing the measured air gap with a predetermined optimal air gap;
a vehicle control module coupled to the controller, the vehicle control module configured to cause the electric vehicle to move one of up and down to adjust the measured air gap towards the predetermined optimal air gap.

18. The electric vehicle of claim 17, further comprising:
an in-vehicle display coupled to the controller, the controller configured to cause the in-vehicle display to display the vehicle height adjustment.

19. The electric vehicle of claim 18, wherein the transmitter coil is a charging pad and the at least one position sensor comprises a downward-facing camera coupled to the controller and configured to capture image data of the charging pad, the image data indicating the position of the transmitter coil relative to a position of the receiver coil.

20. The electric vehicle of claim 19, wherein:
the at least one power level sensor comprises an electromagnetic charging coupler current detector coupled to the controller and configured to detect a current in the receiver coil and send information indicating the detected current to the controller; and
the controller is configured to use the information indicating the detected current to determine the vehicle height adjustment.
